(19) United States
(12) Patent Application Publication
(10) Pub. No.: US 2017/0307078 A1
(43) Pub. Date: Oct. 26, 2017

(54) STEPPED PLANETARY GEAR

(71) Applicants: ZF Friedrichshafen AG, Friedrichshafen (DE); ZF WIND POWER ANTWERPEN N.V., Lommel (BE)

(72) Inventor: Dirk LEIMANN, Edegem (BE)

(21) Appl. No.: 15/534,614

(22) PCT Filed: Nov. 10, 2015
(86) PCT No.: PCT/EP2015/076174

§ 371 Date: Jun. 9, 2017

(30) Foreign Application Priority Data
Dec. 10, 2014 (DE) 10 2014 225 439.6

(51) Int. Cl. F16H 61/688; F16H 57/00; F16H 57/08; F16H 1/28

(52) U.S. Cl. CPC F16H 61/688; F16H 57/082; F16H 57/0025; F16H 2001/2881

(57) ABSTRACT

A planetary gear (101) with a first set of teeth (107) and a second set of teeth (109). The planetary gear comprises two components, namely, a first component (103) and a second component (105). The first component (103) includes the first teeth (107) and the second component (105) includes the second teeth (109). The planetary gear has a first spline connection and a second spline connection (111). The first component (103) includes the first spline connection while the second component (105) includes the second spline connection (111). The second spline connection (111) can be pushed over the first spline connection in such manner that the first spline connection and the second spline connection (111) engage with one another in an interlocking manner.

This application is a National Stage completion of PCT/EP2015/076174 filed Nov. 10, 2015, which claims priority from German patent application serial no. 10 2014 225 439.6 filed Dec. 10, 2014.

### FIELD OF THE INVENTION

The invention relates to a planetary.

### BACKGROUND OF THE INVENTION

A planetary gear is component of a planetary transmission. In addition to a number of planetary gears, the planetary transmission comprises a sun gear with external teeth and a ring gear with internal teeth. As a rule the planetary gears have external teeth and mesh with the sun gear and/or with the ring gear. Furthermore, the planetary gears are mounted to rotate on a planetary carrier.

A planetary transmission is usually designed to have a transmission degree of freedom of 2. A general definition of the term “transmission degree of freedom”, also called transmission running degree, can be found in “Dubbel” (Karl-Heinrich Grote, Jörg Feldhusen: “Dubbel”. 22^{nd} Edition, 2007). Correspondingly, either the planetary carrier is designed to be rotationally fixed whereas the sun gear and the ring gear can rotate, or the sun gear is rotationally fixed whereas the planetary carrier and the ring gear can rotate, or the ring gear is fixed whereas the planetary carrier and the sun gear can rotate. In this, the rotational axes of the planetary carrier, the sun gear and the ring gear are the same. In the case of a rotating planetary carrier, the rotational axes of the sun gears move around the rotational axis of the planetary carrier.

Stepped planetary gears are known from the prior art. As is known, a stepped planetary gear is a planetary gearwheel with two tooth arrays whose pitch circle diameters are different.

As a rule, stepped planetary gears are made integrally. in one piece. To produce the tooth array with the smaller pitch circle diameter a grinding clearance has to be provided between the two tooth arrays. This increases the width of the planetary gear in the axial direction.

The document U.S. Pat. No. 7,008,348 B2 discloses a planetary transmission with stepped planetary gears made in two parts. In this case a first component forms a first tooth array, A second component, which is friction-force-locked onto the first component, forms a second tooth array. This dispenses with the need for a grinding clearance for the first tooth array. However, in addition to the first tooth array a seat has to be made, onto which the second component can be fixed. This makes production more difficult and leads to higher costs.

### SUMMARY OF THE INVENTION

The purpose of the present invention is to make available a stepped planetary gear while avoiding the disadvantages inherent in the solutions known from the prior art. In particular, the stepped planetary gear should be compact and simple to produce.

This objective is achieved by a planetary gear according to the claims.

The planetary gear has a first set of teeth and a second set of teeth.

Preferably, the planetary gear is a stepped planetary gear in which a pitch circle diameter of the second set of teeth is larger than a pitch circle diameter of the first set of teeth. The first and second sets of teeth are designed, in each case to mesh with a set of teeth of a further gearwheel. In particular, the further gearwheel can be a sun gear or a ring gear. Then, the planetary gear with a planetary carrier in which the planetary gear can be mounted, the sun gear and the ring gear, form a planetary transmission.

The planetary gear according to the invention is made in two parts, with a first component and a second component. The first component has the first set of teeth and the second component has the second set of teeth. In other words the first component is provided with the first teeth and the second component with the second teeth.

According to the invention, a first spline connection and a second spline connection are provided. The first component has the first spline connection or forms the first spline connection. The second component has or forms the second spline connection. The second spline connection can be pushed onto the first spline connection, so that the first spline connection and the second spline connection engage with one another in an interlocking manner. Correspondingly, the first spline connection forms an external tooth array and the second spline connection form an internal tooth array. By virtue of the interlocked connection between the first spline connection and the second spline connection, the second component is connected to the first component in a rotationally fixed manner. Furthermore, due to the interlock between the first spline connection and the second spline connection, the second component is fixed radially in the first component. Thus, by virtue of the two arrays of spline connection the second component is fixed relative to the first component in every direction perpendicular to a rotation axis of the planetary gear.

In relation to a displacement in the axial direction, the second component can be fixed onto the first component by friction-force locking. A friction-force locked connection between the first component and the second component can be produced by shrink-fitting the second pass-toothing onto the first pass-toothing. Preferably, however, the second component is fixed with interlock in the first component in the axial direction, for example by means of locking rings.

The two-component design of the planetary gear makes it possible to produce the first set of teeth and the second set of teeth independently of one another. Thus, no grinding clearance is required, This favors a compact structure of the planetary gear.

In a particularly preferred embodiment, a section of the first set of teeth forms the first spline connection. Thus, the first component has just one set of teeth. This meshes not only with the teeth of a further gearwheel, but also functions as the first spline connection. In this case the second spline connection can be pushed onto the first set of teeth so that the first teeth, or that section of the first teeth which forms the first pass-tooth array, engages with interlock and if needs be also by friction-force locking with the second spline connection.

In total therefore, in accordance with this further development the planetary gear has exactly three sets of teeth: the first teeth, the second teeth and the second spline connection.

Since according to the further development the first component has only a single set of teeth, production is simplified. There is no need to produce a separate seat, for example in the form of spline connection, for the second component, Instead, only the first set of teeth must be produced, onto which the second spline connection can then be pushed.

Preferably, the planetary gear can be mounted to rotate on a planetary pin. The planetary pin is fixed rotationally rigidly on the planetary carrier, or in other words the planetary pin cannot rotate relative to the planetary carrier. Preferably, the first component is mounted on bearings so as to rotate on the planetary pin. The planetary pin then fixes the first component radially and preferably also axially. Since the second component is fixed relative to the first component by virtue of the first spline connection and the second spline connection, the second component as well and thus the planetary gear as a whole are fixed relative to the planetary pin.

In a preferred embodiment at least one bearing is used to mount the first component so that it can rotate on the planetary pin. The bearing is arranged at least partially inside the planetary gear.

The inside of the planetary gear is the locus of all points which are not points on the planetary gear itself but which lie on any straight line connecting any two points on the planetary gear. Thus, the inside of the planetary gear is a hollow space within the planetary gear. This hollow space preferably has two openings through which, in the assemble state, the planetary pin extends.

Preferably, the bearing is wholly within the planetary gear. It is also preferable for each bearing by means of which the first component can be mounted to rotate on the planetary pin to be at least partially and preferably completely on the inside of the planetary gear.

### BRIEF DESCRIPTION OF THE DRAWINGS

Preferred example embodiments are illustrated in the figures, in which the same indexes denote the same or functionally equivalent features. In detail, the figures show:

FIG. 1: A hollow stepped planetary gear; and

FIG. 2: A solid stepped planetary gear.

### DETAILED DESCRIPTION OF THE PREFERRED EMBODIMENTS

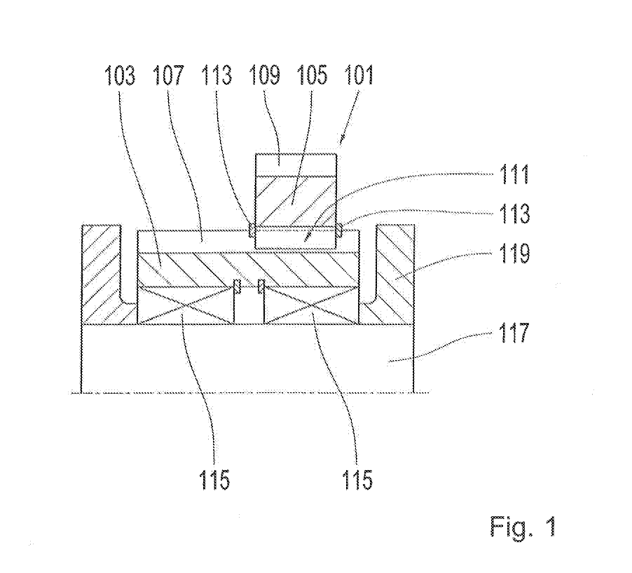

A stepped planetary gear 101 according to FIG. 1 comprises a first component 103 and a second component 105. The first component 103 comprises a first set of teeth 107. The second component 105 comprises a second set of teeth 109. Furthermore, the second component 105 is provided with a spline connection 111 in the form of internal teeth.

The first set of teeth 107 extend in the axial direction over the full width of the first component 103. Correspondingly, the first teeth 107 serve not only to mesh with a further gearwheel, for example a sun gear, but also extend over a section which functions as a spline connection.

Together with the spline connection 111 of the second component 105 these spline connections form an interlocking connection when the second component 105 is pushed onto the first component 103. Consequently, the first component 103 and the second component 105 are rotationally fixed relative to one another and translationally fixed in the radial direction. The first component 103 is fixed axially relative to the second component 105 by means of locking rings 113.

Two bearings 115, which are inside the first component 103, serve to mount the stepped gear 101 so that it can rotate on a planetary pin 117.

Between the planetary pin 117 and the planetary carrier 119 there is a frictional and interlocking fixed connection, which fixes the planetary pin 117 and the planetary carrier 119 so that they cannot move relative to one another.

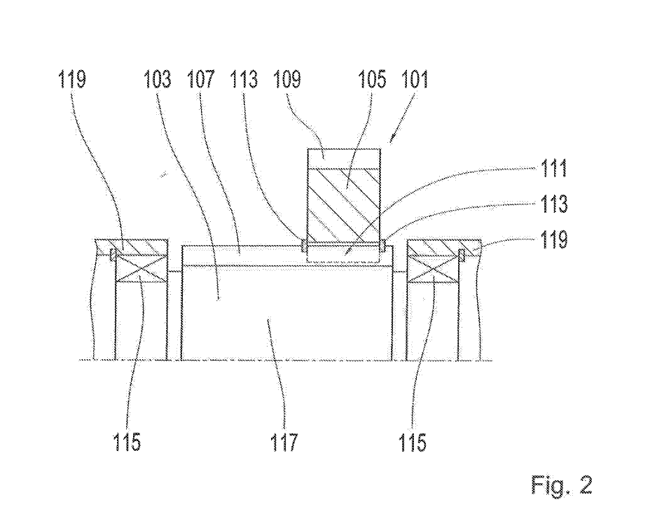

In contrast to the stepped gear 101 shown in FIG. 1, which is a hollow structure, FIG. 2 shows a stepped gear 101 with a solid first component 103. In this case the bearings 115 are arranged displaced to the outside, with their outer races fixed in the planetary carrier 119. The first component 103 of the stepped gear 101 is fixed in the inner races of the bearings 115.

### INDEXES

101 Stepped gear
103 First component
105 Second component
107 First set of teeth
109 Second set of teeth
111 Spline connection
113 Locking ring
115 Bearing
117 Planetary pin
119 Planetary carrier

1-4. (canceled)

5. A planetary gear (101) comprising:
a first set of teeth (107);
a second set of teeth (109);
the planetary gear being made from a first component (103) and a second component (105);
the first component (103) comprising the first set of teeth (107) and the second component (105) comprising the second set of teeth (109);
a first spline connection and a second spline connection (111);
the second component (105) comprising the second spline connection (111); and
the second spline connection (111) can be pushed over the first spline connection in such manner that the first spline connection and the second spline connection (111) engage with one another in an interlocking manner.

6. The planetary gear (101) according to claim 5, wherein a section of the first set of teeth (107) forms the first spline connection.

7. The planetary gear according to claim 5, wherein the first component (103) is mounted for rotation on a planetary pin (117).

8. The planetary gear (101) according to claim 7, wherein the first component (103) is mounted for rotation on the planetary pin (117) by at least one bearing (115); and
the at least one bearing (115) is arranged at least partially located radially inside the planetary gear (101).

9. A stepped planetary gear defining an axis and being supported on a planetary carrier, the stepped planetary gear comprising:
a first component having a first set of teeth which form a first connection spline;
a second component having a second set of teeth which forms a second connection spline;
the second connection splines of the second component interlockingly engage with the first connection splines of the first component such that the first component and the second component are fixed in position relative to one another.

10. The planetary gear according to claim 9, wherein the first connection spline extends along an axial length of the first set of teeth that is only a portion of a total axial length of the first set of teeth.

11. The planetary gear according to claim 9, wherein the first component is rotatably supported on a planetary pin by at least one bearing such that the planetary gear is rotatable with respect to the planetary pin and the planetary carrier.

12. The planetary gear according to claim 11, wherein the at least one bearing is radially arranged at least partially inside the first component.

13. The planetary gear according to claim 9, wherein the second set of teeth are formed on a radially outer side of the second component and the second connection spline is formed on a radially inner side of the second component.

14. The planetary gear according to claim 13, wherein a pitch diameter of the second set of teeth is greater than a pitch diameter of the first set of teeth.
